(19) United States
(12) Patent Application Publication
(10) Pub. No.: US 2005/0158679 A1
(43) Pub. Date: Jul. 21, 2005

(54) Compression-molded vegetable wax-based candle

(76) Inventors: Qin Chen, Westerville, OH (US); Bob Volmert, New Albany, OH (US); Fabian T. DeStefano, Powell, OH (US); Mary Grace P. David, Brampton (CA); John A. Ferguson, Lawrenceville, NJ (US)

Correspondence Address: WARD & OLIVO;Suite 300, 382 Springfield Avenue, Summit, NJ, 07901, US

(21) Appl. No.: 10/760,119

(22) Filed: Jan. 17, 2004

(51) Int. Cl. C11C 5/00; F23C 5/06

(52) U.S. Cl. 431/189; 44/275

(57) ABSTRACT

Prilled wax particles are formed from a vegetable wax-based composition. After compression, a predominantly paraffin wax-based composition is optionally poured over the vegetable wax-based composition to form an encased candle. The method of the present invention offers the possibility to incorporate a high fragrance load to the candle.

### TECHNICAL FIELD OF THE INVENTION

The present invention generally relates to the field of candle making. Specifically, the invention relates to a novel candle composition substantially comprising a vegetable-based wax, and also a paraffin wax and a method for manufacturing same. The candle composition of the present invention is used for manufacturing a compression-molded candle with large fragrance content.

### BACKGROUND OF THE INVENTION

Candles have been used since early civilization. A candle is typically formed of a solid or semi-solid body of lipids or wax material and contains a combustible wick inserted within the candle body. When the wick of a candle is lit, the generated heat melts the solid wax, and the resulting liquid flows up the wick by capillary action and is combusted. Today, candles are still popularly used for purposes such as decoration, holiday celebrations, and aromatherapy.

When candles were first introduced, tallow, and subsequently beeswax, were common base components for candle preparation. More than a hundred years ago, petroleum waxes came into existence, paralleling the development of the petroleum refining industry. The residue leftover from refining gasoline and motor oils produces paraffin wax. As beeswax became more costly and scarcer in supply, paraffin was introduced as a plentiful and low cost alternative.

Currently, paraffin is the primary industrial wax used to produce candles. However, members of the candle making industry, including the applicants, continue to research the utilization of other environmentally-friendly fuel resources which may improve upon the characteristics of previous candles, either alone or in combination with paraffin wax.

For example, it would be desirable to employ other materials in candle manufacturing which are clean burning. Such materials would preferably be biodegradable and derived from renewable resources. They should also preferably have physical characteristics (i.e. melting point, hardness, malleability, etc.) that allow the material to be readily formed into candles with a pleasing appearance, as well as desirable olfactory properties. Candles made from vegetable wax have each of these characteristics.

In the past, however, candles formulated from vegetable wax-based materials have suffered from a variety of problems. For example, in contrast to paraffin-based candles, vegetable wax-derived candles have been previously known to crack, form air pockets, shrink, and/or produce an unpleasant natural odor. It would be advantageous to develop a candle formula and manufacturing method which utilizes vegetable-based waxes, and also achieves the aesthetic and functional qualities sought by consumers. The present invention accomplishes this.

More recently, candles have been created that please the olfactory as well as the visual sense. Typically, these candles incorporate fragrance oil in the wax body. As the wax melts, fragrance is released from the liquefied wax pool.

As fragrant candles became more popular, the ability to increase the level of fragrance became more important. However, drawbacks of conventional high fragrance candles include poor performance and other problems. Incorporating high fragrance oil in candle wax is difficult to achieve in quantities which ensure the release of a suitable level of fragrance into the atmosphere during burning. The effect of gravity in pour-molded candles, for example, causes uneven distribution of components such as fragrance oil within a candle matrix from the top to the bottom, which in turn creates challenges for consistent “straight down” burn. In general, high fragrance load imposes more challenges for a clean and consistent burn. Furthermore, migration and evaporation tends to occur prematurely with the incorporated fragrance. In addition, the fragrance oil softens the candle body, resulting in an undesirable loss of rigidity in the finished candle product.

Normally, candles are prepared by casting, dipping, or otherwise forming candles from molten wax. However, there are economic advantages and candle performance benefits to the utilization of wax powder compression technology.

The preparation of a compressed candle consists of two major processes, granulation and compression. The granulation process involves melting and mixing each ingredient of a candle formula at an elevated temperature. Next the formulated wax particles are formed at a lower temperature through the use of spray drum equipment. The compression process involves the pressing of wax particles using automatic compression equipment such as the Kurschner 6 Stamp Press Machine.

The candle formed by compression-molding of wax particles is affected by formulation variables such as wax melting point, particle shape and size distribution, wax particle affinity to each other, the number and quantity of additives such as fragrances and colorants, and the like, as well as process variables such as total wax particle volume, compression pressure, compression time, and the degree of compression. Previously, the production of a superior candle employing wax powder compression and containing a high fragrance load had not been readily achieved.

Thus, there is a clear need for a vegetable wax-based candle that can be manufactured via compression molding and also contain a high fragrance load.

### SUMMARY OF THE INVENTION

The invention described herein relates to candles having a vegetable wax-based composition with a high fragrance load. In order to obtain a better-quality high fragrance load, candles according to the present invention are compressed, rather than poured, and a superior candle product is achieved. Typically, the candle is formed from a vegetable wax-based composition comprised of a vegetable-based wax and a paraffin wax, wherein the composition has a greater amount of vegetable-based wax than paraffin wax. An encasing layer composed predominantly of paraffin wax can optionally be poured over the compressed vegetable wax-based composition to create an encased candle. The compressed vegetable wax-based composition however, is a complete candle in its own right.

Specifically, the present invention provides for a novel candle composition to create a superior compressed candle product and a method for manufacturing the same. Through the use of compression technology and suitable formulation, it is possible to incorporate a larger amount of fragrance than seen with previous candles. In addition, the use of a vegetable-based wax provides for a cleaner burning, environmentally-friendly candle product.

It is a primary object of the invention described herein to provide a compressed candle product incorporating a high fragrance load comprising a combination of vegetable-based wax composition and a paraffin wax.

It is another object of the invention to provide a method for manufacturing a compressed candle with a high fragrance load.

It is another object of the invention to provide a method and composition to create free-standing candles, such as votives and pillars of various sizes and shapes.

It is another object of the invention to provide a candle containing uniformly distributed color speckles to display a unique appearance which is unachievable through other processes of candle formation.

It is a further object of the invention to provide an encased candle which achieves a prolonged burn with near-complete consumption without leaking or guttering.

It is yet a further object of the invention to provide a compressed candle, formed from a vegetable wax-based composition, encased in a poured encasing layer, wherein the outer encasing layer is composed primarily of paraffin wax.

It is yet a further object of the invention to provide a compressed candle with an encasing layer, wherein the encasing layer has an average melting point equal to, or higher than, the melting point of the vegetable wax-based composition.

It is another object of the invention to provide a compressed candle with exceptional burning behavior.

It is yet another object of the invention to provide a compressed candle comprising up to 25% by weight fragrance.

Other objects, features, and characteristics of the present invention, as well as the methods of operation and functions of the related elements of the structure, and the combination of parts and economies of manufacture, will become more apparent upon consideration of the following detailed description, all of which form a part of this specification.

### DETAILED DESCRIPTION OF THE PREFERRED EMBODIMENT

As required, a detailed illustrative embodiment of the present invention is disclosed herein. However, techniques, systems and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

The following provides a detailed description of the preferred embodiment of the present invention, as well as some alternative embodiments of the invention. As discussed above, the present invention relates generally to a compressed candle formed from a novel vegetable-based wax composition that can incorporate a high fragrance load.

Various vegetable waxes may be used when creating the candle according to the present invention. These waxes may be derived from, but are not limited to, candelilla, carnauba, coconut oil, cottonseed, palm oil, soybean or a combination thereof, or any other waxes known in the candle-making arts. These vegetable waxes are typically comprised of a mixture of triglycerides. They sometimes contain free fatty acids either naturally present in the mixture or blended in during the vegetable wax formation process. The relative amounts of free fatty acids in triglycerides vary with the vegetable source, as well as with the level of processing performed on the vegetable oil. In a preferred embodiment, a vegetable wax comprises 100% triglycerides derived from soybean oil and 0% free fatty acids. Such vegetable wax has a melting point range of 56 to 62 degrees Celsius and an iodine value of 20 to 34. The vegetable wax-based composition comprises at least 50 percent vegetable wax.

In addition to vegetable-derived waxes, petroleum waxes can also be utilized in the present invention. The most common petroleum waxes used in candle manufacturing are paraffin and microcrystalline waxes. Paraffin wax consists predominantly of straight chain hydrocarbons, averaging a chain length of twenty to thirty carbon atoms. The remaining components of paraffin wax include isoparaffins and cycloparaffins. The exact composition of paraffin wax, however, varies from one distillation process to the next. While paraffin waxes tend to be hard and brittle, microcrystalline waxes may vary widely in their physical properties. Generally, microcrystalline waxes have a poorly defined crystalline structure, a higher viscosity, and higher melting points than paraffin waxes. In a preferred embodiment, the petroleum wax component of the vegetable wax-based composition predominantly consists of paraffin wax, with a small percentage of microcrystalline wax functioning as a co-binder. More preferably, the vegetable wax-based portion of the candle comprises approximately 34-43% by weight paraffin wax and approximately 1% by weight microcrystalline wax.

The vegetable wax-based composition may contain up to 49% petroleum waxes, but preferably contains up to 43% petroleum waxes. Additionally, the vegetable wax-based composition comprises at least 50% vegetable wax. Preferably, the vegetable wax-based composition comprises a greater amount of vegetable wax than petroleum waxes.

In addition to vegetable wax and petroleum waxes, a candle formed according to the present invention may also comprise binders, co-binders, UV stabilizers, antioxidants, odorants, or colorants. Suitable binders include polyethylene polymers, such as AC-6 and Vybar 103, although other brands are also acceptable. Binders are necessary additives to enhance the ability of formulated candle wax particles to be held together during and after the compression process. Such binding-ability enhancement becomes even more critical for the formation of compressed candles when high levels of fragrance oil and/or high oil content in waxes are involved. Using the optimum amount of binders should help achieve both the desired compressibility and burning performance of the finished candles. In the present invention, binders are present in the vegetable-based composition, preferably up to 1% by weight.

Co-binders may also be included in the candle composition according to the present invention. In addition to microcrystalline waxes, compounds such as isostearic acid could be used as a co-binder. The presence of co-binders further enhances formulated wax particles' binding ability synergetically, while they also reduce the amount of binders needed for compression to help maintain candle burn performance. Co-binders are preferably present up to 1.5% by weight of the vegetable-based composition.

Furthermore, the candle may additionally comprise UV stabilizers and antioxidants to maintain the stability and prolong the shelf and use life of the candles. Tinuvin 328 and Irganox Antioxidant 1076 from St. Lawrence are examples of UV stabalizers and antioxidants used in the present invention. Preferably, both the UV stabilizers and antioxidants comprise a maximum of 0.2% by weight of the vegetable wax-based composition.

Finally, the candle of the present invention comprises colorants and odorants. Dyes and fragrances are incorporated into the composition by the method outlined below. The fragrance may be synthetically formed, or a naturally derived oil, such as bergamot, orange, lemon, mandarin, caraway, cedar, clove, geranium, lavender, patchouli, rose, and vanilla, in addition to various other fragrances. Fragrance may be present from 0% to 25% by weight, but is preferably present at 8% to 12% by weight of the vegetable wax-based candle composition. Colorants may also be added. Only trace amounts of dye are necessary to achieve an optimal color.

Preferably, the vegetable-based compressed candle composition is approximately 50-51% by weight vegetable wax, 21-48% by weight paraffin wax, 0.5-1.0% by weight binders, 1-1.5% by weight co-binders, 0.15-2.0% by weight UV stabilizers and antioxidants, 0-25% by weight fragrance, and trace amounts of dye.

Compressed candles formed according to the present invention may be various dimensions, including but not limited to, votives and pillars.

In a preferred method of forming a candle according to the present invention, the initial step is to prepare colored and scented vegetable wax-based particles through granulation. The next step is to compress such particles. The colored and scented wax particles and the compressed candle alike, preferably comprise a mixture of vegetable wax, petroleum wax, fragrance oil, binding agents, a UV absorber, an antioxidant, and a dye. The mixture preferably contains more vegetable wax than paraffin wax.

The colored and scented wax particles are formed by initially melting the formulated wax ingredients in a container. Then the wax composition is granulated into small solid wax particles using a spray drum. U.S. Pat. No. 4,614,625 describes in detail methods for prilling wax, and is hereby incorporated by reference. The colored and scented wax particles are then fed into compression molds, compressed, and de-molded with a wick incorporated as a finished candle product.

In an alternative method of forming a candle according to the present invention, the fragrance oils are excluded in the initial step of granulation. Colored wax particles without fragrance oils are prepared according to the method described above. The colored unscented wax particles preferably comprise a mixture of vegetable wax, petroleum wax, binding agents, a UV absorber, an antioxidant and a dye. The mixture preferably contains more vegetable wax than paraffin wax. The colored unscented wax particles are spherical in shape and range in size from 0.3 mm to 0.6 mm in diameter.

In a preferred embodiment, the fragrance oils are encapsulated with paraffin wax, although other types of wax may be used. The fragranced wax particles are similar in size to the colored unscented wax particles. Since the fragrance oils are encapsulated with wax particles, the fragrance carrier is a combustible wax solid instead of liquid oil. Such a method of incorporating fragranced wax particles compatible with the above colored unscented wax particles in size, density and other physical properties for compression ultimately eliminates any direct “thermal heating” involvement for the fragrance oils during the entire candle making process. This enhances the scented candle quality by minimizing the inevitable loss of volatile aromatic components of the fragrance oils during poured candle making process and during the granulation process of the compressed candle making process. Furthermore, it allows even higher load of fragrances to be incorporated into the compressed candle.

Next, the fragranced wax particles are mixed with the colored unscented wax particles through the use of a fluidizing mixer for approximately 1-2 minutes. The mixture is then compressed in the molds of an automatic compression machine at approximately room temperature, thereby yielding the desired candles.

Suitable wicks are either inserted into the candles during or after the compression process to form desired candles.

In an alternative embodiment, color speckles may be added to the mixture of colored and fragranced wax particles. The color speckles are approximately spherical in shape, and range in size from 0.3 mm to 0.6 mm in diameter. Preferably, the color speckles are 0.3 mm in diameter. The color speckles are formed from burnable materials, such as wax, and dye. Preferably, the color speckles are composed of the same wax used in forming the colored and fragranced wax particles. Various colors may be used for the color speckles. Through fluidized mixing with colored and fragranced wax particles, followed by compression, the colored speckles are uniformly incorporated into a compressed candle body. The concentration of color speckles can be up to 50% of the total mixture, but more preferably are present at 1% to 5%.

Following compression, it may be desirable to add an encasing layer to the compressed vegetable-based composition of the candle, except when making a votive candle. Encased candles provide for a consistent and prolonged burn, i.e., anywhere from six to twelve hours per burning cycle without leaking and guttering. A compressed vegetable wax-based composition, along with an encasing layer, results in near-complete consumption of the candle without leaking and guttering.

In an alternative embodiment of the present invention, the encasing layer of wax can contain up to 92 percent by weight of paraffin wax, but more preferably, this layer will contain 76-86% by weight of paraffin wax. In yet another alternative composition, the encasing layer comprises from 30-61% by weight paraffin wax, but preferably from 48-56% paraffin wax. Additionally, this alternative encasing composition may comprise 25-30% by weight vegetable wax. In general, smaller amounts of paraffin wax in the encasing layer will result in the candle having a more natural appearance.

Further, the encasing layer can comprise binders, such as the polymer Vybar 103. Vybar 103 also acts as an opacifier. The binder may be present up to 2% by weight of the encasing layer composition, but is preferably present at 1-1.5% by weight.

Furthermore, fatty acid is added to the encasing layer composition. Suitable fatty acids include stearic acid, palmitic acid and oleic acid, or a combination thereof. Preferably stearic acid is used, such as Emersol 132 from Cognis. Fatty acids are preferably present at 5-7.5% by weight of the encasing layer composition. In an alternative composition of the encasing layer, fatty acids comprise approximately 3% by weight of the composition.

In addition, co-binders, UV stabilizers, dyes, and fragrance are also added to the encasing composition. Co-binders, UV stabilizers, and dyes are present in small amounts. The fragrance in the encasing layer is in the form of oil, and may range from 0% to 25% by weight of the encasing composition. Preferably, the fragrance oil comprises 5 to 12% by weight of the encasing layer.

The average melting point of the formulated encasing wax layer should be equal or slightly higher than that of the compressed vegetable wax-based composition.

An encased candle, according to the present invention, is formed by placing the compressed vegetable wax-based composition in the center of a mold. The mold can be made from aluminum, silicone, or any other viable material known in the candle-making arts for making molds. The mold should be greater in diameter than the compressed vegetable wax-based composition, preferably approximately ¼ inches greater. Then, formulated wax for the encasing layer is liquefied, poured into the mold, and allowed to cool.

Overall, the encased candle consists of 65-80% by weight of the compressed vegetable wax-based composition, and 20 to 35% by weight of the encasing layer, which is a petroleum wax-based composition. In a preferred embodiment, the candle comprises 75% by weight of the compressed vegetable wax-based composition and 25% by weight of encasing layer. The weight percentages of vegetable and paraffin waxes in such a candle vary. The total composition, then, may comprise less vegetable wax than paraffin wax or vice versa, depending on the amount of fragrance incorporated into the composition. In general, an encased candle formed according to the present invention will have more petroleum wax than vegetable wax when smaller percentages of fragrance are incorporated into the candle. Conversely, the encased candle will have more vegetable wax than petroleum wax when it contains larger percentages of fragrance.

Preferably, the encased candle is 37.88% by weight vegetable wax, 45.10-53.73% by weight paraffin wax, 0.75-1.1% by weight binders, 1.3%-1.6% by weight co-binders, 1.3-1.9% by weight fatty acid, 0.15-0.40% by weight UV absorber/antioxidants, trace amounts of dye and 5-12% by weight fragrance. The appropriate ranges for all components of the encased candles are: 32.8 to 40.4% by weight vegetable wax, 30.0 to 63.1% by weight paraffin wax, 0.70 to 1.2% by weight binders, 1.2 to 1.7% by weight co-binders, 1.3 to 2.6% by weight fatty acid, 0.15 to 0.48% by weight UV stabilizer/antioxidant, and 0.0 to 25.0% fragrance oils.

In an alternative embodiment of the encased candle, the encased candle is 42-49% by weight vegetable wax, 23-52% by weight paraffin wax, 0.5-1.00% binders, 2.3-4.1% co-binders, 0.45-0.9% fatty acid, 0.25-0.4% UV-stabilizers/antioxidants, trace amounts of dye and 0.0-25% by weight fragrance. Preferably, the alternative embodiment comprises 36-37% by weight paraffin wax. Through the use of less paraffin wax in the encasing layer, a more natural-looking candle is achieved.

The encased candles formed according to the present invention offer exceptional burning behavior. Specifically, the candles burn cleanly, and show no leaking or guttering over a prolonged burn, i.e. six to twelve hours per burning cycle. In addition, close to 90% consumption of the candle body is achieved.

In addition, the encased candles according to the present invention also offer a variety of surface appearances, all while maintaining the high level of fragrance. Exterior appearances include, but are not limited to smooth texture, rough textures, crackles, embossed, and debossed looks. Surface effects can usually be achieved through the use of silicone or aluminum molds.

While the present invention has been described with reference to one or more preferred embodiments, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and principles of the invention. It should be appreciated that the present invention is capable of being embodied in other forms without departing from its essential characteristics.

1. A vegetable wax-based composition suitable for manufacturing a candle by compression, comprising:
a vegetable-based wax; and
a petroleum wax,
wherein said composition comprises a greater amount of said vegetable-based wax than said petroleum wax.

2. A vegetable wax-based composition according to claim 1, wherein said vegetable-based wax has a melting point of 56 to 62° C. and an iodine value of 22 to 34.

3. A vegetable wax-based composition according to claim 1, wherein said petroleum wax is a paraffin wax.

4. A vegetable wax-based composition according to claim 1, wherein said petroleum wax has a melting point of 55 to 61° C.

5. A vegetable wax-based composition according to claim 1, wherein said composition includes a fragrance.

6. A vegetable wax-based composition according to claim 5, wherein said fragrance is present up to 25% by weight.

7. A vegetable wax-based composition according to claim 1, wherein said vegetable wax-based composition comprises at least 50% by weight of said vegetable-based wax.

8. A vegetable wax-based composition according to claim 1, wherein said vegetable wax-based composition comprises at most 49% by weight of said petroleum wax.

9. A vegetable wax-based composition according to claim 1, wherein said vegetable wax-based composition includes a binder.

10. A vegetable wax-based composition according to claim 1, wherein said vegetable wax-based composition includes a colorant.

11. A vegetable wax-based composition according to claim 1, wherein said vegetable wax-based composition includes an antioxidant.

12. A vegetable wax-based composition according to claim 1, wherein said vegetable wax-based composition includes a UV absorber.

13. A vegetable wax-based composition according to claim 1, wherein said vegetable wax-based composition includes a co-binder.

14. A vegetable wax-based composition according to claim 1, wherein said vegetable wax-based composition is encased in an encasing layer.

15. A vegetable wax-based composition according to claim 14, wherein said encasing layer consists substantially of a petroleum wax.

16. A vegetable wax-based composition according to claim 14, wherein the average melting point of said outer layer is greater than the average melting point of said vegetable wax-based composition.

17. A vegetable wax-based composition according to claim 14, wherein said vegetable wax-based composition comprises at least 65% by weight of said candle.

18. A vegetable wax-based composition according to claim 14, wherein said encasing layer comprises at most 35% by weight of said candle.

19. A vegetable wax-based composition according to claim 1, wherein said vegetable wax-based composition further comprises color speckles.

20. A vegetable wax-based composition suitable for manufacturing a candle by compression, comprising:
a vegetable-based wax; and
a petroleum wax,
wherein said vegetable wax-based composition comprises a greater amount of said vegetable-based wax than said petroleum wax,
wherein said vegetable wax-based composition is further encased in an encasing layer, and
wherein said encasing layer consists substantially of a petroleum wax.

21. A vegetable wax-based composition according to claim 20, wherein said vegetable-based wax has a melting point of 56 to 62° C. and an iodine value of 20 to 34.

22. A vegetable wax-based composition according to claim 20, wherein said petroleum wax is a paraffin wax.

23. A vegetable wax-based composition according to claim 20, wherein said petroleum wax has a melting point of 55 to 61° C.

24. A vegetable wax-based composition according to claim 20, wherein said vegetable wax-based composition includes a fragrance.

25. A vegetable wax-based composition according to claim 24, wherein said fragrance is present up to 25% by weight.

26. A vegetable wax-based composition according to claim 20, wherein said vegetable wax-based composition comprises at least 50% by weight of said vegetable-based wax.

27. A vegetable wax-based composition according to claim 20, wherein said vegetable wax-based composition comprises at most 49% by weight of said petroleum wax.

28. A vegetable wax-based composition according to claim 20, wherein said vegetable wax-based composition includes a binder.

29. A vegetable wax-based composition according to claim 20, wherein said vegetable wax-based composition includes a colorant.

30. A vegetable wax-based composition according to claim 20, wherein said vegetable wax-based composition includes an antioxidant.

31. A vegetable wax-based composition according to claim 20, wherein said vegetable wax-based composition includes a UV absorber.

32. A vegetable wax-based composition according to claim 20, wherein said vegetable wax-based composition includes a co-binder.

33. A vegetable wax-based composition according to claim 20, wherein the melting point of said encasing layer is greater than the melting point of said vegetable wax-based composition.

34. A vegetable wax-based composition according to claim 20, wherein said vegetable wax-based composition comprises at least 65% by weight of said candle.

35. A vegetable wax-based composition according to claim 20, wherein said encasing layer comprises at most 35% by weight of said candle.

36. A vegetable wax-based composition according to claim 20, wherein said vegetable wax-based composition further comprises color speckles.

37. A vegetable wax-based composition suitable for manufacturing a candle by compression, comprising:
a vegetable-based wax;
a petroleum wax;
a binder; and
a fragrance,
wherein said vegetable wax-based composition comprises a greater amount of said vegetable-based wax than said petroleum wax.

38. A vegetable wax-based composition according to claim 37, wherein said vegetable-based wax has a melting point of 56 to 62° C. and an iodine value of 20 to 34.

39. A vegetable wax-based composition according to claim 37, wherein said petroleum wax is paraffin wax.

40. A vegetable wax-based composition according to claim 37, wherein said petroleum wax has a melting point of 55 to 61° C.

41. A vegetable wax-based composition according to claim 37, wherein said fragrance is present up to 25% by weight.

42. A vegetable wax-based composition according to claim 37, wherein said vegetable wax-based composition comprises at least 50% by weight of said vegetable-based wax.

43. A vegetable wax-based composition according to claim 37, wherein said vegetable wax-based composition comprises at most 49% by weight of said petroleum wax.

44. A vegetable wax-based composition according to claim 37, wherein said vegetable wax-based composition includes a colorant.

45. A vegetable wax-based composition according to claim 37, wherein said vegetable wax-based composition includes an antioxidant.

46. A vegetable wax-based composition according to claim 37, wherein said vegetable wax-based composition includes a UV absorber.

47. A vegetable wax-based composition according to claim 37, wherein said vegetable wax-based composition includes a co-binder.

48. A vegetable wax-based composition according to claim 37, wherein said vegetable wax-based composition is encased in an encasing layer.

49. A vegetable wax-based composition according to claim 48, wherein said encasing layer consists substantially of a petroleum wax.

50. A vegetable wax-based composition according to claim 48, wherein the melting point of said encasing layer is greater than the melting point of said vegetable wax-based composition.

51. A vegetable wax-based composition according to claim 48, wherein said vegetable wax-based composition comprises at least 65% by weight of said candle.

52. A vegetable wax-based composition according to claim 48, wherein said encasing layer comprises at most 35% by weight of said candle.

53. A vegetable wax-based composition according to claim 37, wherein said vegetable wax-based composition further comprises color speckles.

54. A vegetable wax-based composition suitable for manufacturing a candle by compression, comprising:
a vegetable-based wax;
a petroleum wax;
a binder; and
a fragrance,
wherein said vegetable wax-based composition comprises a greater amount of said vegetable-based wax than said petroleum wax, and
wherein said vegetable wax-based composition is further encased in an encasing layer, and
wherein said encasing layer consists substantially of a petroleum wax.

55. A vegetable wax-based composition according to claim 54, wherein said vegetable-based wax has a melting point of 56 to 62° C. and an iodine value of 20 to 34.

56. A vegetable wax-based composition according to claim 54, wherein said petroleum wax is a paraffin wax.

57. A vegetable wax-based composition according to claim 54, wherein said petroleum wax has a melting point of 55 to 61° C.

58. A vegetable wax-based composition according to claim 54, wherein said fragrance is present up to 25% by weight.

59. A vegetable wax-based composition according to claim 54, wherein said composition comprises at least 50% by weight of said vegetable-based wax.

60. A vegetable wax-based composition according to claim 54, wherein said vegetable wax-based composition comprises at most 49% by weight of said petroleum wax.

61. A vegetable wax-based composition according to claim 54, wherein said composition includes a colorant.

62. A vegetable wax-based composition according to claim 54, wherein said composition includes an antioxidant.

63. A vegetable wax-based composition according to claim 54, wherein said composition includes a UV absorber.

64. A vegetable wax-based composition according to claim 54, wherein said composition includes a co-binder.

65. A vegetable wax-based composition according to claim 54, wherein the melting point of said encasing layer is greater than the melting point of said vegetable wax-based composition.

66. A vegetable wax-based composition according to claim 54, wherein said vegetable wax-based composition comprises at least 65% by weight of said candle.

67. A vegetable wax-based composition according to claim 54, wherein said encasing layer comprises at most 35% by weight of said candle.

68. A vegetable wax-based composition according to claim 54, wherein said vegetable wax-based composition further comprises color speckles.

69. A combustible candle composition, comprising:
a vegetable wax-based composition comprising petroleum wax and vegetable wax, and
an encasing layer comprising petroleum wax;
wherein said vegetable wax-based composition comprises a greater amount of said vegetable wax than said petroleum wax,
wherein said vegetable wax-based composition is formed via compression,
wherein said encasing layer is poured over said inner core, and
wherein said candle composition comprises a greater amount of said petroleum wax than said vegetable-based wax.

70. A candle composition according to claim 69, wherein said candle composition includes a fragrance.

71. A candle composition according to claim 70, wherein said fragrance is present up to 25% by weight.

72. A candle composition according to claim 69, wherein said vegetable wax has a melting point of 56 to 62° C. and an iodine value of 20 to 34.

73. A candle composition according to claim 69, wherein said petroleum wax is a paraffin wax.

74. A candle composition according to claim 69, wherein said petroleum wax has a melting point of 55 to 61° C.

75. A candle composition according to claim 69, wherein said candle composition includes a binder.

76. A candle composition according to claim 69, wherein said candle composition includes a colorant.

77. A candle composition according to claim 69, wherein said candle composition includes an antioxidant.

78. A candle composition according to claim 69, wherein said candle composition includes a UV absorber.

79. A candle composition according to claim 69, wherein said candle composition includes a co-binder.

80. A candle composition according to claim 69, wherein the melting point of said encasing layer is greater than the melting point of said vegetable wax-based composition.

81. A candle composition according to claim 69, wherein said vegetable wax-based composition comprises at least 65% by weight of said candle.

82. A candle composition according to claim 69, wherein said encasing layer comprises at most 35% by weight of said candle.

83. A candle composition according to claim 69, wherein said candle composition further comprises color speckles.

84. A combustible candle composition, comprising:
a vegetable wax-based composition comprising petroleum wax and vegetable wax, and an encasing layer comprising petroleum wax;
wherein said vegetable wax-based composition comprises a greater amount of said vegetable wax than said petroleum wax,
wherein said vegetable wax-based composition is formed via compression,
wherein said encasing layer is poured over said vegetable wax-based composition, and
wherein said candle composition comprises a greater amount of said vegetable-based wax than said petroleum wax.

85. A candle composition according to claim 84, wherein said candle composition also includes a fragrance.

86. A candle composition according to claim 85, wherein said fragrance is present from 15-25% by weight.

87. A candle composition according to claim 84, wherein said vegetable-based wax has a melting point of 56 to 62° C. and an iodine value of 20 to 34.

88. A candle composition according to claim 84, wherein said petroleum wax is a paraffin wax.

89. A candle composition according to claim 84, wherein said petroleum wax has a melting point of 55 to 61° C.

90. A candle composition according to claim 84, wherein said candle composition includes a binder.

91. A candle composition according to claim 84, wherein said candle composition includes a colorant.

92. A candle composition according to claim 84, wherein said candle composition includes an antioxidant.

93. A candle composition according to claim 84, wherein said candle composition includes a UV absorber.

94. A candle composition according to claim 84, wherein said candle composition includes a co-binder.

95. A candle composition according to claim 84, wherein the melting point of said encasing layer is greater than the melting point of said vegetable wax-based composition.

96. A candle composition according to claim 84, wherein said vegetable wax-based composition comprises at least 65% by weight of said candle.

97. A candle composition according to claim 84, wherein said encasing layer comprises at most 35% by weight of said candle.

98. A candle composition according to claim 84, wherein said composition further comprises color speckles.

99. A method of making candles comprising the steps of:
prilling a vegetable wax-based composition to form granules;
compressing said granules,
wherein said vegetable wax-based composition comprises a vegetable-based wax and a petroleum wax, and
wherein said vegetable wax-based composition comprises a greater amount of said vegetable-based wax than said petroleum wax.

100. A method according to claim 99, wherein said vegetable wax-based composition includes a colorant.

101. A method according to claim 99, wherein said vegetable wax-based composition includes a fragrance.

102. A method according to claim 101, wherein said fragrance is present up to 25% by weight.

103. A method according to claim 99, wherein said vegetable-based wax has a melting point of 56 to 62° C. and an iodine value of 22 to 32.

104. A method according to claim 99, wherein said petroleum wax is a paraffin wax.

105. A method according to claim 99, wherein said petroleum wax has a melting point of 55 to 61° C.

106. A method according to claim 99, wherein said vegetable wax-based composition comprises at least 50% by weight of said vegetable-based wax.

107. A method according to claim 99, wherein said vegetable wax-based composition comprises at most 49% by weight of said petroleum wax.

108. A method according to claim 99, wherein said candle includes a binder.

109. A method according to claim 99, wherein said candle includes an antioxidant.

110. A method according to claim 99, wherein said candle includes a UV absorber.

111. A method according to claim 99, wherein said candle includes a co-binder.

112. A method according to claim 99, wherein said method comprises a further step of encasing said vegetable wax-based composition with an encasing layer.

113. A method according to claim 112, wherein said encasing layer consists substantially of a petroleum wax.

114. A method according to claim 112, wherein the average melting point of said encasing layer is greater than the average melting point of said vegetable wax-based composition.

115. A method according to claim 112, wherein said vegetable wax-based composition comprises at least 65% by weight of said candle.

116. A method according to claim 112, wherein said encasing layer comprises at most 35% by weight of said candle.

117. A method according to claim 99, wherein said method further comprises embossing said candle via a mold.

118. A method according to claim 99, wherein said method further comprises debossing said candle via a mold.

119. A method of making candles comprising the steps of:
prilling a vegetable wax-based composition to form granules;
compressing said granules; and
encasing said vegetable wax-based composition with an encasing layer;
wherein said vegetable wax-based composition comprises a vegetable-based wax and a petroleum wax, and
wherein said vegetable wax-based composition comprises a greater amount of said vegetable-based wax than said petroleum wax, and
wherein said encasing layer consists substantially of a petroleum wax.

120. A method according to claim 119, wherein said vegetable wax-based composition includes a colorant.

121. A method according to claim 119, wherein said vegetable wax-based composition includes a fragrance.

122. A method according to claim 121, wherein said fragrance is present up to 25% by weight.

123. A method according to claim 119, wherein said vegetable-based wax has a melting point of 56 to 62° C. and an iodine value of 20 to 34.

124. A method according to claim 119, wherein said petroleum wax is a paraffin wax.

125. A method according to claim 119, wherein said petroleum wax has a melting point of 55 to 61° C.

126. A method according to claim 119, wherein said vegetable wax-based composition comprises at least 50% by weight of said vegetable-based wax.

127. A method according to claim 119, wherein said vegetable wax-based composition comprises at most 49% by weight of said petroleum wax.

128. A method according to claim 119, wherein said candle includes a binder.

129. A method according to claim 119, wherein said candle includes an antioxidant.

130. A method according to claim 119, wherein said candle includes a UV absorber.

131. A method according to claim 119, wherein said candle includes a co-binder.

132. A method according to claim 119, wherein said method further comprises embossing said candle via a mold.

133. A method according to claim 119, wherein said method further comprises debossing said candle via a mold.
